(19) United States
(12) Patent Application Publication
(10) Pub. No.: US 2026/0034712 A1
(43) Pub. Date: Feb. 5, 2026

(54) INJECTION MOLDING APPARATUS

(71) Applicant: SEIKO EPSON CORPORATION, Tokyo (JP)

(72) Inventor: Tetsuya TAMURA, MATSUMOTO-SHI (JP)

(21) Appl. No.: 19/284,505

(22) Filed: Jul. 29, 2025

(30) Foreign Application Priority Data
Jul. 31, 2024 (JP) 2024-124463

(51) Int. Cl. B29C 45/23; B29C 45/74

(52) U.S. Cl. CPC B29C 45/234; B29C 45/74; B29K 2995/0013

(57) ABSTRACT

An injection molding apparatus includes a plasticizing unit configured to plasticize a material and generate a molding material, a nozzle communicating with the plasticizing unit and being configured to eject the molding material, and a die clamping device configured to open and close a molding die into which the molding material is ejected from the nozzle, wherein the nozzle includes a flow path through which the molding material flows, an ejection port communicating with the flow path and being configured to eject the molding material, an opening/closing mechanism including at least a part positioned in the flow path and being configured to open and close the ejection port, and a spring configured to apply a biasing force to the opening/closing mechanism, and at least a part of the spring is supported by the plasticizing unit.

The present application is based on, and claims priority from JP Application Serial Number 2024-124463, filed Jul. 31, 2024, the disclosure of which is hereby incorporated by reference herein in its entirety.

### BACKGROUND

### 1. Technical Field

The present disclosure relates to an injection molding apparatus.

### 2. Related Art

For example, JP-A-2019-151036 discloses a valve nozzle that operates a piston by a resin pressure to open and close a gate. In the valve nozzle, when the resin pressure is less than a predetermined value, a coil spring biases the piston in an anti-gate direction, and thus the gate is held in a closed state. The above-mentioned coil spring is provided in a molten resin flow path provided inside the valve nozzle.

In the injection molding apparatus in which the spring is provided in the flow path inside the nozzle, the size of the nozzle may be increased, and a shape of a molding die that can be used for injection molding.

### SUMMARY

According to a first aspect of the present disclosure, an injection molding apparatus is provided. The injection molding apparatus includes a plasticizing unit configured to plasticize a material and generate a molding material, a nozzle communicating with the plasticizing unit and being configured to eject the molding material, and a die clamping device configured to open and close a molding die into which the molding material is ejected from the nozzle, wherein the nozzle includes a flow path through which the molding material flows, an ejection port communicating with the flow path and being configured to eject the molding material, an opening/closing mechanism including at least a part positioned in the flow path and being configured to open and close the ejection port, and a spring configured to apply a biasing force to the opening/closing mechanism, and at least a part of the spring is supported by the plasticizing unit.

### BRIEF DESCRIPTION OF THE DRAWINGS

FIG. 1 is a top view illustrating a schematic configuration of an injection molding apparatus.

FIG. 2 is a perspective view illustrating a schematic configuration of the injection molding apparatus.

FIG. 3 is a cross-sectional view illustrating a schematic configuration of an injection unit.

FIG. 4 is a perspective view illustrating a schematic configuration of a flat screw.

FIG. 5 is a schematic plan view of a barrel.

FIG. 6 is a perspective view of the barrel and a nozzle.

FIG. 7 is a perspective view of the barrel and the nozzle, which is taken along a cross-section including a flow path.

FIG. 8 is a perspective view of a spring.

FIG. 9 is a perspective view of the spring and a lever.

FIG. 10 is a cross-sectional view schematically illustrating a configuration of a periphery of an opening/closing mechanism.

FIG. 11 is a cross-sectional view schematically illustrating a configuration of the periphery of the opening/closing mechanism.

FIG. 12 is a diagram for describing a position of a heating unit included in an injection unit.

FIG. 13 is a cross-sectional view of the barrel, a barrel case, and the nozzle.

FIG. 14 is a diagram for describing a position of the spring in a second embodiment.

FIG. 15 is a diagram for describing a position of the spring in a third embodiment.

### DESCRIPTION OF EMBODIMENTS

### A. First Embodiment

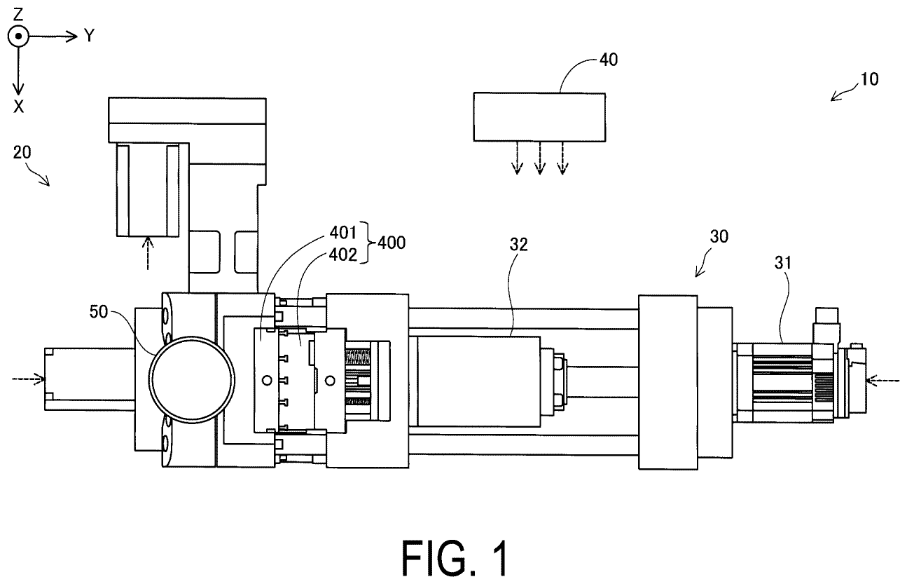

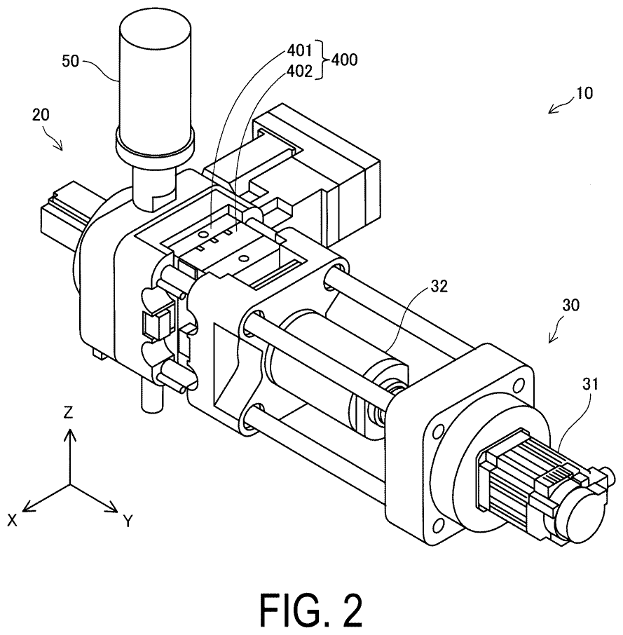

FIG. 1 is a top view illustrating a schematic configuration of an injection molding apparatus 10. FIG. 2 is a perspective view illustrating a schematic configuration of the injection molding apparatus 10. In FIG. 1 and FIG. 2, arrows indicating X, Y, and Z directions orthogonal to one another are illustrated. The X direction and the Y direction are directions parallel to a horizontal plane. The Z direction is a direction parallel to a vertical direction. The X, Y, and Z directions in FIG. 1 and FIG. 2 and the X, Y, and Z directions in the other drawings indicate the same directions. When orientation is specified, positive and negative signs are used together to represent directions, where “+” represents a positive direction, which is a direction represented by the arrow, and “−” represents a negative direction, which is opposite to the direction represented by the arrow.

The injection molding apparatus 10 includes an injection unit 20, a die clamping device 30, and a control unit 40. The injection molding apparatus 10 injects the molding material from the injection unit 20 into a molding die 400 mounted to the die clamping device 30. Thus, a molded article is molded. Note that, in the present specification, injection of the molding material may also be expressed as ejection of the molding material. The injection molding apparatus 10 is a lateral injection molding apparatus, and the injection unit 20 and the die clamping device 30 are arrayed in the horizontal direction. The control unit 40 is configured as a computer including a CPU and a memory, and controls the respective units of the injection molding apparatus 10 by executing a program stored in the memory by the CPU. Note that the control unit 40 may be configured as a circuit.

The molding die 400 formed of metal is mounted to the die clamping device 30. The molding die 400 formed of metal is referred to as a metal die. The molding die 400 includes a fixed die 401 and a movable die 402. The fixed die 401 is a die fixed to the injection unit 20. The movable die 402 is a die that can advance and retract in a die clamping direction with respect to the fixed die 401 by the die clamping device 30. In the embodiment, the die clamping direction is the −Y direction.

The die clamping device 30 includes a function of opening and closing the fixed die 401 and the movable die 402. Under control of the control unit 40, the die clamping device 30 rotates a ball spring 32 by driving a die driving unit 31 configured by a motor, moves the movable die 402 coupled to the ball spring 32 with respect to the fixed die 401, and thus opens and closes the molding die 400.

A hopper 50 into which a material of the molded article is put is coupled to the injection unit 20. For example, as the material of the molded article, a thermal resin in a pellet form is used. For example, as the thermal plastic resin, acrylonitrile butadiene styrene (ABS), polycarbonate (PC), polyacetal (POM), polypropylene (PP), polybutylene terephthalate (PBT), or the like is used. In addition to the thermal resin, the material of the molded article may contain metal or ceramic. The material may be supplied to the injection unit 20 via a tube in which the material is force-fed, in place of the hopper 50.

The injection unit 20 plasticizes at least a part of the material supplied from the hopper 50, generates the molding material, and injects the molding material thus generated into a cavity defined between the fixed die 401 and the movable die 402. In the present specification, “plasticization” is a concept that includes melting, and refers to changing a solid into a state with fluidity. Specifically, for a material that undergoes glass transition, plasticization refers to raising a temperature of the material above the glass transition point. For a material that does not undergo glass transition, plasticization refers to raising a temperature of the material above the melting point.

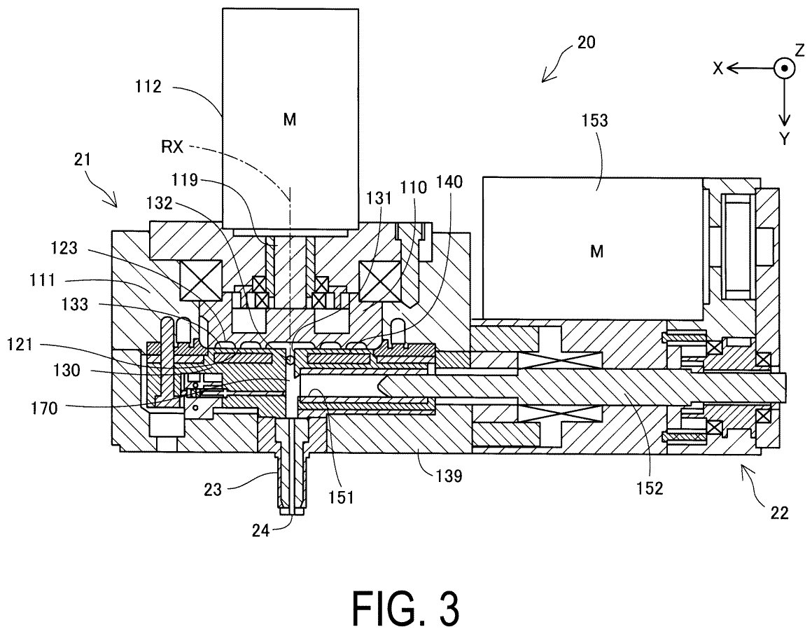

FIG. 3 is a cross-sectional view illustrating a schematic configuration of the injection unit 20. The injection unit 20 includes a plasticizing unit 21, a suction delivery unit 22, and a nozzle 23.

The plasticizing unit 21 plasticizes at least a part of the material supplied from the hopper 50, and generates the molding material. The plasticizing unit 21 includes a flat screw 110, a screw case 111, a barrel 130, a barrel case 139, and a first heating unit 140.

The flat screw 110 is accommodated in the screw case 111. The flat screw 110 is rotated about a driving shaft 119 of a driving motor 112 inside the screw case 111 by the driving motor 112. A center axis RX being a rotation center of the flat screw 110 matches with the center of the driving shaft 119 of the driving motor 112 in the XZ plane. In the embodiment, the driving shaft 119 and the axial direction of the center axis RX extend along the Y direction. Rotation of the flat screw 110 by the driving motor 112 is controlled by the control unit 40. Note that the flat screw 110 may be driven by the driving motor 112 via a speed reducer. The flat screw 110 is referred to as a rotor, or is also simply referred to as a screw.

The barrel 130 is housed in the barrel case 139. A communication hole 131 is formed in the center of the barrel 130. The communication hole 131 communicates with a flow path 170 through which the molding material flows. A cylinder 151 and a nozzle 23, which are described later, are coupled to the flow path 170. In the flow path 170, a check valve 132 is provided to an upstream portion with respect to the cylinder 151. The check valve 132 prevents reverse flow of the molding material from the nozzle 23 side to the flat screw 110 side.

The first heating unit 140 heats the molding material in the plasticizing unit 21. The first heating unit 140 is a heater.

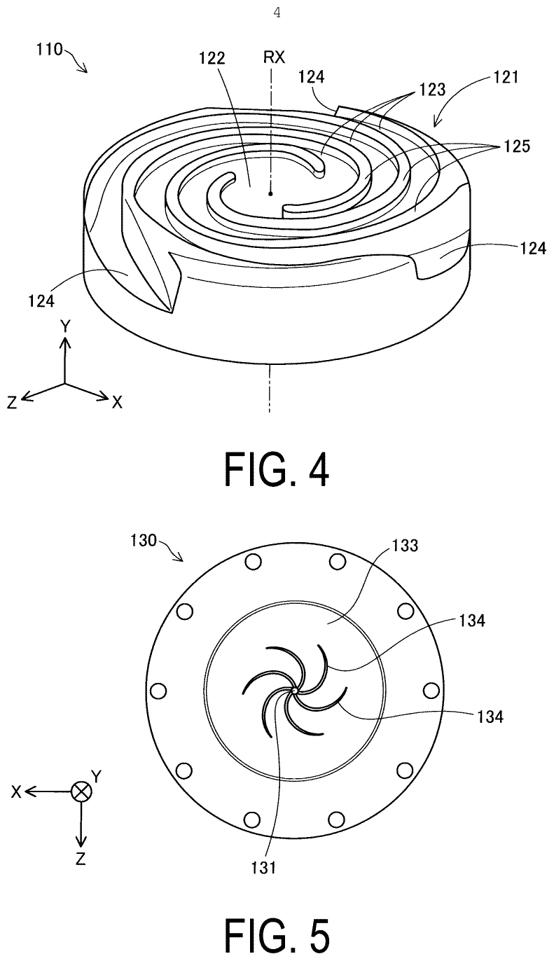

FIG. 4 is a perspective view illustrating a schematic configuration of the flat screw 110. The flat screw 110 has a substantially columnar shape whose length in a direction along the center axis RX is smaller than its length in a direction perpendicular to the center axis RX. In a groove formation surface 121 of the flat screw 110, which faces the barrel 130, a spiral groove 123 is formed around a center portion 122. The groove 123 communicates with a material inlet 124 formed in a side surface of the flat screw 110. The material supplied from the hopper 50 is supplied to the groove 123 through the material inlet 124. The groove 123 is formed by being separated by a protrusion portion 125. FIG. 4 illustrates an example in which three grooves 123 are formed. However, the number of grooves 123 may be one, two, or more. Note that the groove 123 is not limited to a spiral shape, and may be a helical shape, an involute curved shape, or a shape extending in an arc from the center portion 122 toward the outer periphery.

FIG. 5 is a schematic plan view of the barrel 130. The barrel 130 includes a counter surface 133 facing the groove formation surface 121 of the flat screw 110. At the center of the counter surface 133, the communication hole 131 is formed. In the counter surface 133, a plurality of guide grooves 134 that are coupled to the communication hole 131 and extend spirally from the communication hole 131 toward the outer periphery are formed. Note that the guide grooves 134 may not be provided to the barrel 130. Further, the guide grooves 134 may not be coupled to the communication hole 131.

The material supplied to the groove 123 of the flat screw 110 is plasticized between the flat screw 110 and the barrel 130 by rotation of the flat screw 110 and heating of the first heating unit 140, flows along the groove 123 and the guide grooves 134 by rotation of the flat screw 110, and is guided to the center portion 122 of the flat screw 110. The material flowing into the center portion 122 flows out from the communication hole 131 provided at the center of the barrel 130 to the flow path 170.

As illustrated in FIG. 3, the suction delivery unit 22 includes the cylinder 151, a plunger 152, and a plunger driving unit 153. The suction delivery unit 22 includes a function of injecting the molding material in the cylinder 151 into the cavity of the molding die 400. Under control of the control unit 40, the suction delivery unit 22 controls an injection amount, an injection speed, and an injection pressure of the molding material from the nozzle 23. The cylinder 151 is a substantially cylindrical member coupled to the flow path 170, and includes the plunger 152 inside. The plunger 152 slides inside the cylinder 151, and force-feeds the molding material in the cylinder 151 to the nozzle 23. The plunger 152 is driven by the plunger driving unit 153 configured by a motor.

The nozzle 23 communicates with the plasticizing unit 21. The flow path 170 is formed in the nozzle 23. The nozzle 23 includes an ejection port 24 that communicates with the flow path 170 and ejects the molding material. The plunger 152 force-feeds the molding material in the cylinder 151 to the nozzle 23. With this, the molding material is injected from the ejection port 24 to the molding die 400.

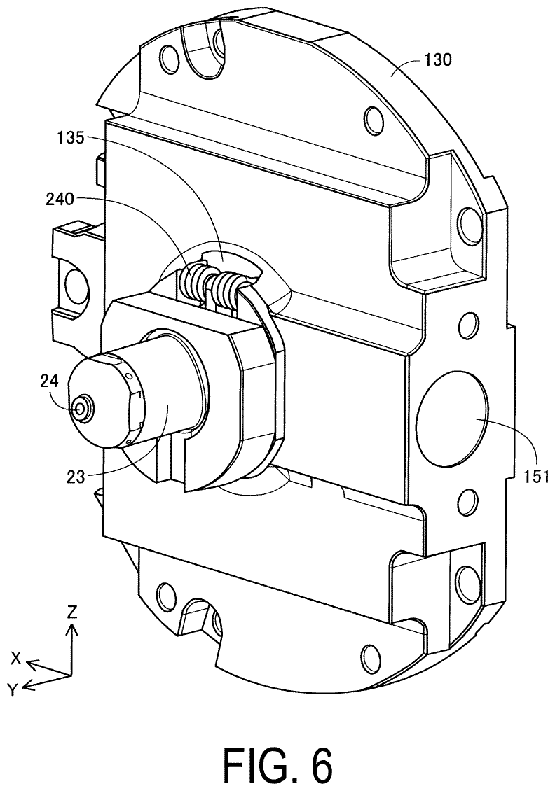

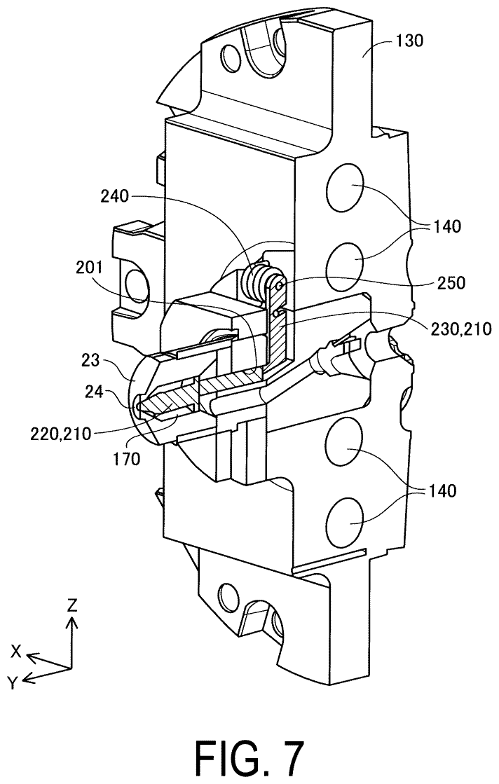

FIG. 6 is a perspective view of the barrel 130 and the nozzle 23. FIG. 7 is a perspective view of the barrel 130 and the nozzle 23, which is taken along a cross-section including the flow path 170. As illustrated in FIG. 7, the nozzle 23 includes an opening/closing mechanism 210 that opens and closes the ejection port 24. The opening/closing mechanism 210 is provided so that at least a part thereof is positioned in the flow path 170. In the embodiment, the opening/closing mechanism 210 is configured by a piston 220 and a lever 230. In FIG. 7, in order to clearly illustrate the opening/closing mechanism 210, the cross-section of the piston 220 and the cross-section of the lever 230 are hatched. Further, the injection unit 20 includes a spring 240 that applies a biasing force to the opening/closing mechanism 210.

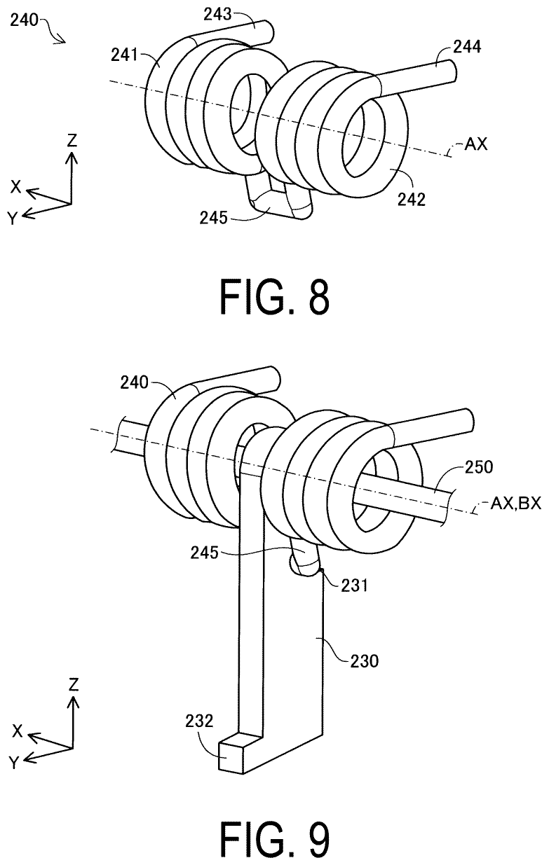

FIG. 8 is a perspective view of the spring 240. In the embodiment, the spring 240 is a torsion spring. The spring 240 includes a first coil portion 241, a second coil portion 242, a first arm portion 243, a second arm portion 244, and a third arm portion 245. The first coil portion 241 and the second coil portion 242 are provided so that the axial line of the first coil portion 241 and the axial line of the second coil portion 242 match with each other. In the following description, the axial line of the first coil portion 241 and the axial line of the second coil portion 242 are also referred to as an axial line AX of the spring 240. Further, the first coil portion 241 and the second coil portion 242 are also collectively referred to as a coil portion. In the embodiment, a direction along the axial line AX of the spring 240 is the X direction. The first coil portion 241 is provided on the +X direction side of the second coil portion 242. The first arm portion 243 extends in the −Y direction from the end portion of the first coil portion 241 on the +X direction side. The second arm portion 244 extends in the −Y direction from the end portion of the second coil portion 242 on the −X direction side. The first arm portion 243 and the second arm portion 244 are fixed to the barrel 130. The third arm portion 245 is provided between the first coil portion 241 and the second coil portion 242, and is coupled to the end portion of the first coil portion 241 on the −X direction side and the end portion of the second coil portion 242 on the +X direction side. The third arm portion 245 protrudes in the —Z direction with respect to the outer diameter of the coil portion.

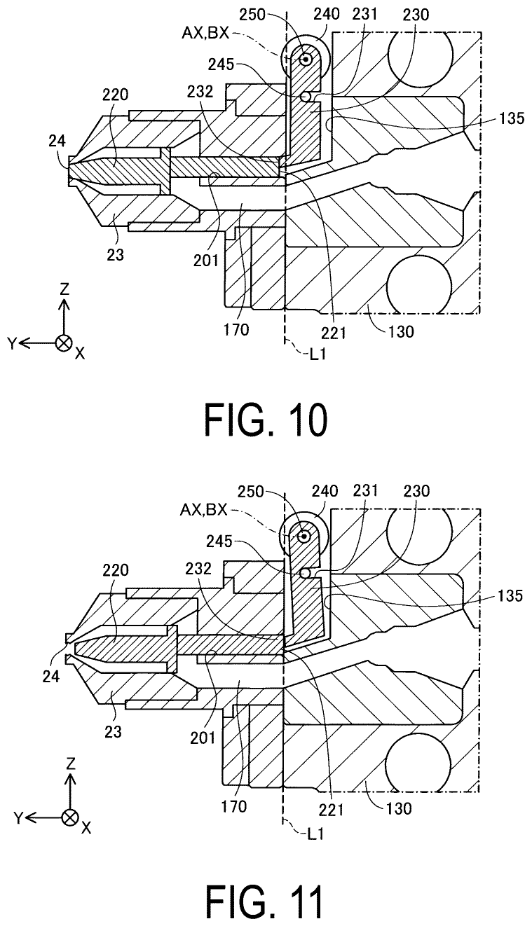

FIG. 9 is a perspective view of the spring 240 and the lever 230. FIG. 10 and FIG. 11 are cross-sectional views schematically illustrating a configuration of the periphery of the opening/closing mechanism 210. FIG. 10 illustrates a state in which the ejection port 24 is closed, and FIG. 11 illustrates a state in which the ejection port 24 is opened. With reference to FIG. 7 and FIG. 9 to FIG. 11, the configuration and the operation of the opening/closing mechanism 210 are described below.

The spring 240 and the lever 230 are attached to the barrel 130 by a shaft member 250 extending in the X direction. A part of the shaft member 250 is positioned inside the coil portion of the spring 240 and a through hole (omitted in illustration) that is provided at the end portion of the lever 230 on the +Z direction and passes through the lever 230 in the X direction. In other words, the spring 240 is attached to the plasticizing unit 21, and is supported by the plasticizing unit 21. The lever 230 is provided so as to rotate about the shaft member 250 within the YZ plane. In the embodiment, an axial line BX of the shaft member 250 matches with the axial line AX of the spring 240. Note that the axial line BX of the shaft member 250 may not match with the axial line AX of the spring 240. Further, in the surface of the lever 230 on the −Y direction side, a groove 231 passing through the lever 230 in the X direction is formed. In the groove 231, the third arm portion 245 of the spring 240 is arranged. That is, the lever 230 contacts the spring 240 at the groove 123. The spring 240 applies a biasing force to the lever 230 so that the lever 230 rotates about the axial line BX of the shaft member 250 in a clockwise direction as viewed in the −X direction. In this state, the first arm portion 243 and the second arm portion 244 of the spring 240 are supported by the plasticizing unit 21, and the third arm portion 245 of the spring 240 is supported by the opening/closing mechanism 210. The lever 230 and the shaft member 250 may be integrally formed.

The lever 230 transmits the biasing force of the spring 240 to the piston 220. At the end portion of the lever 230 on the −Z direction side, a first end surface 232 being a surface protruding in the +Y direction is formed. As illustrated in FIG. 10 and FIG. 11, the lever 230 contacts with the piston 220 at the first end surface 232. The entirety of the first end surface 232 may contact with the piston 220, or only a part thereof may contact with the piston 220. In the following description, a portion of the lever 230 that contacts the piston 220 is referred to as a first contact portion. In other words, the first end surface 232 includes the first contact portion.

The lever 230 is formed of a material having thermal conductivity lower than that of the piston 220. In the embodiment, the lever 230 if formed of polyetheretherketone (PEEK). Note that the lever 230 may be formed of a resin other than PEEK, ceramic, metal, or the like.

The piston 220 opens and closes the ejection port 24 of the nozzle 23. The piston 220 is provided so that at least a part thereof is positioned in the flow path 170. The piston 220 is provided so as to be movable in the direction in which the molding material flows in the flow path 170. In the embodiment, the piston 220 is provided so as to be movable in the Y direction. The piston 220 moves in the +Y direction, and the end portion of the piston 220 on the +Y direction side and the ejection port 24 contact with each other. With this, the ejection port 24 is closed. Further, the piston 220 moves in the −Y direction, and the end portion of the piston 220 on the +Y direction side and the ejection port 24 are separated from each other. With this, the ejection port 24 is opened. In the following description, the end portion of the piston 220 on the +Y direction side is also referred to as a distal end, and the end portion thereof on the −Y direction side is also referred to as a rear end.

The rear end side of the piston 220 is arranged inside a first hole 201 that is formed in the nozzle 23 and passes through the nozzle 23 in the Y direction. An end surface of the rear end of the piston 220 contacts with the first end surface 232 of the lever 230. In the following description, the end surface of the rear end of the piston 220 is referred to as a second end surface 221. Further, a part of the piston 220 that contacts the lever 230 is referred to as a second contact portion. In other words, the second end surface 221 includes the second contact portion. The area of the second end surface 221 including the second contact portion is larger than the area of the first end surface 232 including the first contact portion. In other words, the area of the first end surface 232 including the first contact portion is smaller than the area of the second end surface 221 including the second contact portion.

In the embodiment, the piston 220 is formed of SUS. Note that the piston 220 may be formed of metal other than SUS, ceramic, or the like. The piston 220 is preferably formed of a material having heat resistance.

When the molding material is not present in flow path 170, or a pressure of the molding material in the flow path 170 is less than a predetermined value, the piston 220 is biased in the +Y direction by a biasing force of the spring 240 as illustrated in FIG. 10. With this, the ejection port 24 is closed. Specifically, when the third arm portion 245 of the spring 240 biases the lever 230, the lever 230 rotates about the shaft member 250 in a clockwise direction as viewed in the −X direction, and the first end surface 232 of the lever 230 presses the second end surface 221 of the piston 220. With this, the piston 220 is biased in the +Y direction. When a pressure of the molding material, in the flow path 170 is greater than the predetermined value, the pressure of the molding material exceeds a biasing force of the spring 240, and the piston 220 moves in the −Y direction as illustrated in FIG. 11. With this, the ejection port 24 is opened. Herein, the predetermined value for the pressure of the molding material is determined based on a type of the molding material, a biasing force of the spring 240, or the like.

As illustrated in FIG. 6, FIG. 10, and FIG. 11, the spring 240 is provided in a recess portion 135 formed in a surface of the barrel 130 on the nozzle 23 side. In the embodiment, the surface of the barrel 130 on the nozzle 23 side is the surface of the barrel 130 on the +Y direction side. The spring 240 is provided in the recess portion 135 so that the axial line AX is positioned on the plasticizing unit 21 side with respect to the boundary between the plasticizing unit 21 and the nozzle 23. In the embodiment, the position at which the surface of the barrel 130 on the +Y direction side and the surface of the nozzle 23 on the −Y direction side contact with each other corresponds to the boundary between the plasticizing unit 21 and the nozzle 23. In FIG. 10 and FIG. 11, the boundary between the plasticizing unit 21 and the nozzle 23 is denoted with the broken line L1.

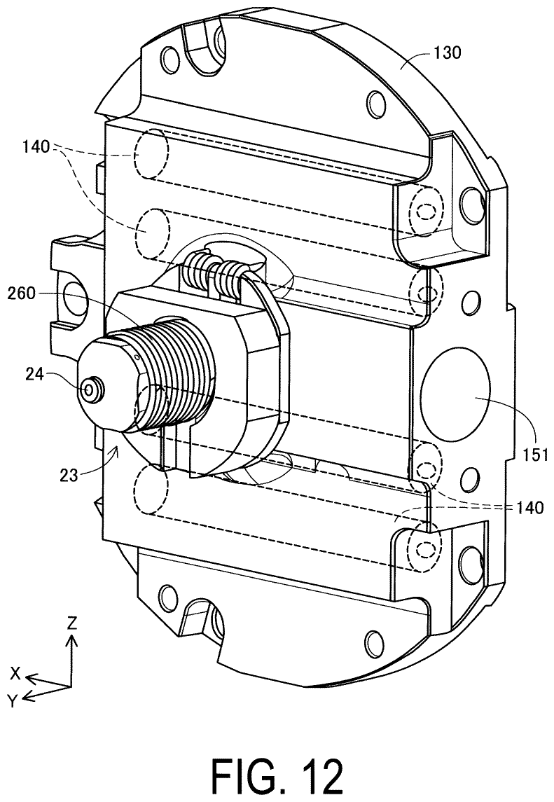

FIG. 12 is a diagram illustrating the position of the heating unit included in the injection unit 20. In FIG. 12, the first heating unit 140 embedded inside the barrel 130 is indicated with the broken line. In the embodiment, the first heating unit 140 is configured by four rod-like heaters extending in the X direction. Note that the first heating unit 140 may be configured by one or more and three or less, or five or more heaters, and may have a shape other than a rod-like shape. Further, the nozzle 23 includes a second heating unit 260 that heats the molding material in the flow path 170. The second heating unit 260 is a coil heater and is wound around the nozzle 23. A space is provided between the second heating unit 260 and the spring 240.

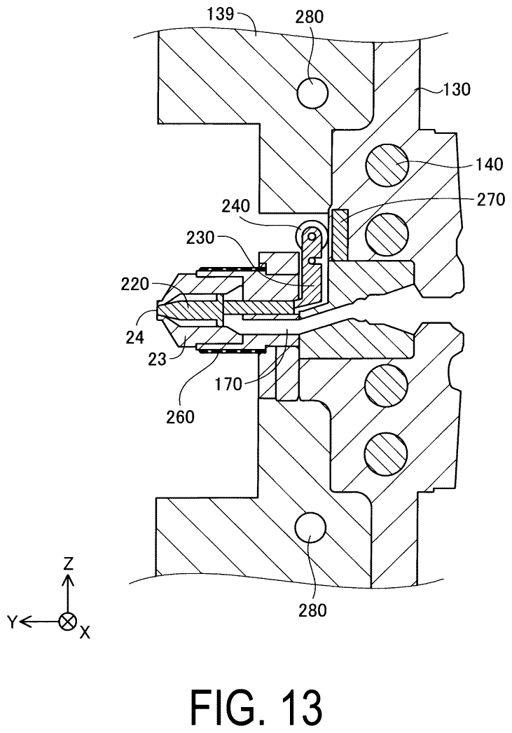

FIG. 13 is a cross-sectional view of the barrel 130, the barrel case 139, and the nozzle 23. As illustrated in FIG. 13, the barrel 130 includes a heat insulating member 270. The heat insulating member 270 is embedded inside the barrel 130 so as to be positioned between the first heating unit 140 and the spring 240. The heat insulating member 270 is made of, for example, glass fiber, ceramic, or the like. Note that the heat insulating member 270 may be provided to the outer surface of the barrel 130 so as to be positioned between the first heating unit 140 and the spring 240.

The plasticizing unit 21 includes a cooling unit 280 that cools the plasticizing unit 21. In the embodiment, the cooling unit 280 is provided in the barrel case 139. The cooling unit 280 is a refrigerant flow path through which a refrigerant flows. The cooling unit 280 is coupled to a refrigerant pump (omitted in illustration) that supplies the refrigerant to the cooling unit 280. Examples of the refrigerant include a liquid such as water and oil and a gas such as carbon dioxide. The temperature of the refrigerant flowing through the cooling unit 280 is controlled by the control unit 40. When the refrigerant flows through the cooling unit 280, the plasticizing unit 21 is cooled. The cooling unit 280 may be provided in the barrel 130.

According to the injection molding apparatus 10 of the first embodiment described above, the spring 240 that applies a biasing force to the opening/closing mechanism 210 for opening and closing the ejection port 24 of the nozzle 23 is supported by the plasticizing unit 21, and is not provided in the flow path 170. Thus, the size of the nozzle 23 can be reduced, and the possibility that the shape of the molding die 400 that can be used for injection molding is limited can be lowered. Further, when the spring 240 is provided in the flow path 170, it is difficult to increase the temperature of the molding material flowing through the flow path 170 in view of thermal resistance of the spring 240. However, in the embodiment, the spring 240 is not provided in the flow path 170. Thus, the temperature of the molding material flowing through the flow path 170 can be increased.

Further, in the embodiment, the spring 240 is a torsion spring, and the axial line AX of the spring 240 is positioned on the plasticizing unit 21 side with respect to the boundary between the plasticizing unit 21 and the nozzle 23. Thus, the size of the nozzle 23 can be reduced, and the possibility that the shape of the molding die 400 that can be used for injection molding is limited can be lowered.

Further, in the embodiment, the spring 240 is positioned in the recess portion 135 of the plasticizing unit 21. Thus, the size of the nozzle 23 can be reduced, and the possibility that the shape of the molding die 400 that can be used for injection molding is limited can be lowered.

Further, in the embodiment, the plasticizing unit 21 includes the heat insulating member 270 provided between the spring 240 and the first heating unit 140. Thus, the strength degradation of the spring 240 due to the heat of the first heating unit 140 can be suppressed.

Further, in the embodiment, the space is provided between the spring 240 and the second heating unit 260. Thus, the air present between the spring 240 and the second heating unit 260 insulates the heat of the second heating unit 260. With this, the strength degradation of the spring 240 due to the heat of the second heating unit 260 can be suppressed.

Further, in the embodiment, the area of the first end surface 232 of the lever 230, which includes the first contact portion, is smaller than the area of the second end surface 221 of the piston 220, which includes the second contact portion. Thus, the heat propagation of the piston 220 to the lever 230 can be suppressed. As a result, the heat propagation of the piston 220 to the spring 240 contacting with the lever 230 can be suppressed, and the strength degradation of the spring 240 due to the heat can be suppressed.

Further, in the embodiment, the thermal conductivity of the lever 230 is lower than the thermal conductivity of the piston 220. Thus, the heat propagation of the piston 220 to the spring 240 via the lever 230 can be suppressed, and the strength degradation of the spring 240 due to the heat can be suppressed.

### B. Second Embodiment

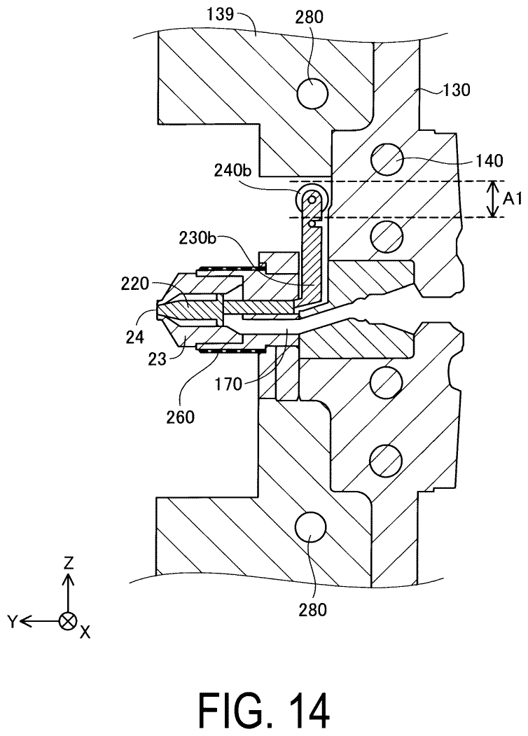

FIG. 14 is a diagram for describing a position of a spring 240b in a second embodiment. The second embodiment is different from the first embodiment in a position of the spring 240b and a length of a lever 230b in the Z direction. Further, in the second embodiment, the barrel 130 does not include the heat insulating member 270. The configurations of the respective units of the injection molding apparatus 10 other than the spring 240b, the lever 230b, and the heat insulating member 270 are the same as those in the first embodiment.

As illustrated in FIG. 14, the spring 240b is positioned in a region A1 that does not overlap with the first heating unit 140 in a direction in which the plasticizing unit 21 and the nozzle 23 are arrayed. In the embodiment, the direction in which the plasticizing unit 21 and the nozzle 23 are arrayed is the Y direction. The spring 240b is attached to the barrel 130 so as to be positioned between the two first heating units 140, which are arranged on the +Z direction side with respect to the flow path 170, in the Z direction. Further, the spring 240b is positioned on the +Z direction side with respect to the spring 240 in the first embodiment. Thus, the length of the lever 230b in the Z direction is more than the length of the lever 230 in the first embodiment.

According to the second embodiment described above, the heat of the first heating unit 140 is less likely to be transmitted to the spring 240b as compared to a case in which the spring 240b is positioned in the region overlapping with the first heating unit 140 in the direction in which the plasticizing unit 21 and the nozzle 23 are arrayed. Thus, the strength degradation of the spring 240b due to the heat of the first heating unit 140 can be suppressed.

### C. Third Embodiment

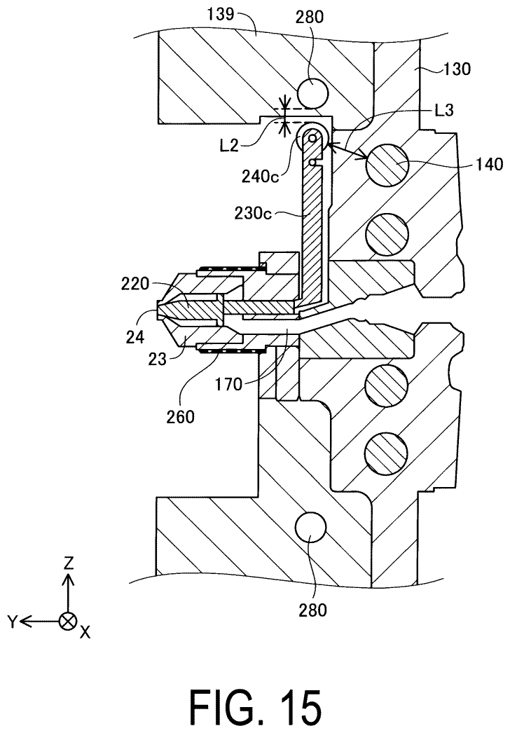

FIG. 15 is a diagram for describing a position of a spring 240c in a third embodiment. The third embodiment is different from the first embodiment in a position of the spring 240c and a length of a lever 230c in the Z direction. Further, in the third embodiment, the barrel 130 does not include the heat insulating member 270. The configurations of the respective units of the injection molding apparatus 10 other than the spring 240c, the lever 230c, and the heat insulating member 270 are the same as those in the first embodiment.

The spring 240c is provided at a position at which a distance L2 between the spring 240c and the cooling unit 280 is less than a distance L3 between the spring 240c and the first heating unit 140. Herein, the distance L2 is the shortest distance between the spring 240c and the cooling unit 280, and the distance L3 is the shortest distance between the spring 240c and the first heating unit 140. Note that, when the plurality of first heating units 140 are present, the distance L3 is the shortest distance between the spring 240c and the first heating unit 140 closest to the spring 240c. As illustrated in FIG. 15, the distance L2 between the cooling unit 280 provided on the +Z direction side with respect to the flow path 170 and the spring 240c is less than the distance L3 between the first heating unit 140 positioned closest to the +Z direction side and the spring 240c. Further, the spring 240c is positioned on the +Z direction side with respect to the spring 240 in the first embodiment. Thus, the length of the lever 230c in the Z direction is more than the length of the lever 230 in the first embodiment.

According to the third embodiment described above, the distance between the spring 240c and the cooling unit 280 is less than the distance between the spring 240c and the first heating unit 140. Thus, the spring 240c is cooled by the cooling unit 280. Thus, the strength degradation of the spring 240c due to the heat of the first heating unit 140 can be suppressed.

### D. Other Embodiments

(D-1) In the above-mentioned embodiment, the spring 240 is a torsion spring. In contrast, the spring 240 is only required to have such a shape that can apply a biasing force to the opening/closing mechanism 210, and may be a coil spring, a plate spring, or the like. A case in which the spring 240 is a coil spring is described below. The spring 240 is provided between the opening/closing mechanism 210 and the plasticizing unit 21. Specifically, the spring 240 includes one end fixed to the surface of the barrel 130 on the +Y direction side, and the other end fixed to the surface of the lever 230 in the −Y direction side. The spring 240 applies a biasing force to the lever 230 so that the lever 230 rotates about the axial line BX of the shaft member 250 in a clockwise direction as viewed in the −X direction. In this state, the one end of the spring 240 is supported by the plasticizing unit 21, and the other end of the spring 240 is supported by the opening/closing mechanism 210. Note that any one of the one end and the other end of the spring 240 may not be fixed.

(D-2) In the above-mentioned embodiment, the spring 240 is positioned in the recess portion 135 of the plasticizing unit 21. In contrast, the spring 240 may not be positioned in the recess portion 135. Further, the plasticizing unit 21 may not include the recess portion 135.

(D-3) In the above-mentioned embodiment, the plasticizing unit 21 includes the heat insulating member 270. In contrast, the plasticizing unit 21 may not include the heat insulating member 270.

(D-4) In the above-mentioned embodiment, the space is provided between the spring 240 and the second heating unit 260. In contrast, the space may not be provided between the spring 240 and the second heating unit 260.

(D-5) In the above-mentioned embodiment, the area of the first end surface 232 including the first contact portion is smaller than the area of the second end surface 221 including the second contact portion. In contrast, the area of the first end surface 232 including the first contact portion may not be smaller than the area of the second end surface 221 including the second contact portion.

(D-6) In the above-mentioned embodiment, the thermal conductivity of the lever 230 is lower than the thermal conductivity of the piston 220. In contrast, the thermal conductivity of the lever 230 may not be lower than the thermal conductivity of the piston 220.

(D-7) In the above-mentioned embodiment, the opening/closing mechanism 210 is configured by the piston 220 and the lever 230. In contrast, the opening/closing mechanism 210 may be configured by one member, or may be configured by three or more members.

(D-8) In the above-mentioned embodiment, the injection molding apparatus 10 is a lateral injection molding apparatus. In contrast, the injection molding apparatus 10 may be a vertical injection molding apparatus.

### E. Other Modes

The present disclosure is not limited to the embodiments described above, and may be achieved in various aspects without departing from the spirits of the disclosure. For example, the present disclosure may be achieved through the following aspects. Appropriate replacements or combinations may be made to the technical features in the above-described embodiments which correspond to the technical features in the aspects described below to solve some or all of the problems of the disclosure or to achieve some or all of the advantageous effects of the disclosure. Further, even when technical characteristics are not described as essential ones in the present specification, it is possible to delete the technical characteristics in the embodiments appropriately.

(1) According to a first aspect of the present disclosure, an injection molding apparatus is provided. The injection molding apparatus includes a plasticizing unit configured to plasticize a material and generate a molding material, a nozzle communicating with the plasticizing unit and being configured to eject the molding material, and a die clamping device configured to open and close a molding die into which the molding material is ejected from the nozzle, wherein the nozzle includes a flow path through which the molding material flows, an ejection port communicating with the flow path and being configured to eject the molding material, an opening/closing mechanism including at least a part positioned in the flow path and being configured to open and close the ejection port, and a spring configured to apply a biasing force to the opening/closing mechanism, and at least a part of the spring is supported by the plasticizing unit.

According to such an aspect, the spring is not provided in the flow path. Thus, the size of the nozzle can be reduced, and the possibility that the shape of the molding die that can be used for injection molding is limited can be lowered.

(2) In the above-mentioned aspect, the spring may be a torsion spring, and an axial line of the spring may be positioned on the plasticizing unit side with respect to a boundary between the plasticizing unit and the nozzle.

According to such an aspect, the size of the nozzle can be reduced, and the possibility that the shape of the molding die that can be used for injection molding is limited can be lowered.

(3) In the above-mentioned aspect, the plasticizing unit may include a recess portion, and the spring may be positioned in the recess portion.

According to such an aspect, the size of the nozzle can be reduced, and the possibility that the shape of the molding die that can be used for injection molding is limited can be lowered.

(4) In the above-mentioned aspect, the plasticizing unit may include a first heating unit configured to heat the molding material in the plasticizing unit, and a heat insulating member provided between the spring and the first heating unit.

According to such an aspect, the strength degradation of the spring due to the heat of the first heating unit can be suppressed.

(5) In the above-mentioned aspect, the nozzle may include a second heating unit configured to heat the molding material in the flow path, and a space may be provided between the spring and the second heating unit.

According to such an aspect, the air present between the spring and the second heating unit thermally insulates the heat of the second heating unit. Thus, the strength degradation of the spring due to the heat of the second heating unit can be suppressed.

(6) In the above-mentioned aspect, the plasticizing unit may include a first heating unit configured to heat the molding material in the plasticizing unit, and the spring may be positioned in a region that does not overlap with the first heating unit in a direction in which the plasticizing unit and the nozzle are arrayed.

According to such an aspect, the strength degradation of the spring due to the heat of the first heating unit can be suppressed.

(7) In the above-mentioned aspect, the plasticizing unit may include a first heating unit configured to heat the molding material in the plasticizing unit, and a cooling unit configured to cool the plasticizing unit, and a distance between the spring and the cooling unit may be less than a distance between the spring and the first heating unit.

According to such an aspect, the strength degradation of the spring due to the heat of the first heating unit can be suppressed.

(8) In the above-mentioned aspect, the opening/closing mechanism may include a piston including at least a part provided in the flow path and being configured to open and close the ejection port, and a lever configured to contact the spring and transmit a biasing force of the spring to the piston, and an area of a first end surface of the lever including a first contact portion that contacts the piston contact is smaller than an area of a second end surface of the piston including a second contact potion that contacts the lever contact.

According to such an aspect, transmission of the heat of the piston to the spring via the lever can be suppressed. Thus, the strength degradation of the spring due to the heat can be suppressed.

(9) In the above-mentioned aspect, the opening/closing mechanism may include a piston including at least a part provided in the flow path and being configured to open and close the ejection port, and a lever configured to contact the spring and transmit a biasing force of the spring to the piston, and thermal conductivity of the lever is lower than thermal conductivity of the piston.

According to such an aspect, transmission of the heat of the piston to the spring via the lever can be suppressed. Thus, the strength degradation of the spring due to the heat can be suppressed.

What is claimed is:

1. An injection molding apparatus, comprising:
a plasticizing unit configured to plasticize a material and generate a molding material;
a nozzle communicating with the plasticizing unit and being configured to eject the molding material; and
a die clamping device configured to open and close a molding die into which the molding material is ejected from the nozzle, wherein
the nozzle includes:
a flow path through which the molding material flows;
an ejection port communicating with the flow path and being configured to eject the molding material;
an opening/closing mechanism including at least a part positioned in the flow path and being configured to open and close the ejection port; and
a spring configured to apply a biasing force to the opening/closing mechanism, and
at least a part of the spring is supported by the plasticizing unit.

2. An injection molding apparatus according to claim 1, wherein
the spring is a torsion spring, and
an axial line of the spring is positioned on the plasticizing unit side with respect to a boundary between the plasticizing unit and the nozzle.

3. An injection molding apparatus according to claim 1, wherein
the plasticizing unit includes a recess portion, and
the spring is positioned in the recess portion.

4. An injection molding apparatus according to claim 1, wherein
the plasticizing unit includes:
a first heating unit configured to heat the molding material in the plasticizing unit; and
a heat insulating member provided between the spring and the first heating unit.

5. An injection molding apparatus according to claim 1, wherein
the nozzle includes a second heating unit configured to heat the molding material in the flow path, and
a space is provided between the spring and the second heating unit.

6. An injection molding apparatus according to claim 1, wherein
the plasticizing unit includes a first heating unit configured to heat the molding material in the plasticizing unit, and
the spring is positioned in a region that does not overlap with the first heating unit in a direction in which the plasticizing unit and the nozzle are arrayed.

7. An injection molding apparatus according to claim 1, wherein
the plasticizing unit includes:
a first heating unit configured to heat the molding material in the plasticizing unit; and
a cooling unit configured to cool the plasticizing unit, and
a distance between the spring and the cooling unit is less than a distance between the spring and the first heating unit.

8. An injection molding apparatus according to claim 1, wherein
the opening/closing mechanism includes:
a piston including at least a part provided in the flow path and being configured to open and close the ejection port; and
a lever configured to contact the spring and transmit a biasing force of the spring to the piston, and
an area of a first end surface of the lever including a first contact portion that contacts the piston is smaller than an area of a second end surface of the piston including a second contact potion that contacts the lever contact.

9. An injection molding apparatus according to claim 1, wherein
the opening/closing mechanism includes:
a piston including at least a part provided in the flow path and being configured to open and close the ejection port; and
a lever configured to contact the spring and transmit a biasing force of the spring to the piston, and
thermal conductivity of the lever is lower than thermal conductivity of the piston.
